(19) United States
(12) Patent Application Publication
(10) Pub. No.: US 2022/0415181 A1
(43) Pub. Date: Dec. 29, 2022

(54) VIRTUAL DYNAMIC PLATOON

(71) Applicant: Nokia Technologies Oy, Espoo (FI)

(72) Inventors: Junwen WANG, Shanghai (CN); Xiaopeng LV, Shanghai (CN); Yonggen WAN, Shanghai (CN)

(21) Appl. No.: 17/787,637

(22) PCT Filed: Dec. 23, 2019
(86) PCT No.: PCT/CN2019/127570

§ 371 Date: Jun. 21, 2022

(51) Int. Cl. G08G 1/00; G08G 1/0967; B60W 50/06; B60W 60/00; B60W 30/14; B60W 10/18; B60W 10/20

(52) U.S. Cl. CPC G08G 1/22; G08G 1/096725; G08G 1/096741; G08G 1/096791; B60W 50/06; B60W 60/001; B60W 30/143; B60W 10/18; B60W 10/20; B60W 2520/00; B60W 2556/00

(57) ABSTRACT

Embodiments of the present disclosure relates to dynamic virtual platoon. According to embodiments of the present disclosure, a first device receives driving information from vehicles and forwards the driving information to a network device. The second device determines the vehicle platoon based on the driving information and transmits the information related to the vehicle platoon to the first device. The first device determines control information to remotely drive the vehicles. In this way, the coverage of the vehicle platoon is increased and a dynamic platoon is formed. The first device controls the driving of the vehicles instead of the head vehicle, which reduces burden on the head vehicle.

### FIELD

Embodiments of the present disclosure generally relate to communication techniques, and more particularly, to methods, devices and computer readable medium for virtual dynamic platoon.

### BACKGROUND

With the process of urbanization, urban traffic problems are becoming worse and worse. At the same time, autonomous driving and car networking technologies have also accelerated development. There are several types of vehicle network applications, for example, public platoon and private platoon. Requirements on the public platoon and private platoon are different since characteristics of the public platoon and private platoon are different.

### SUMMARY

Generally, embodiments of the present disclosure relate to a method for virtual dynamic platoon.

In a first aspect, there is provided a method. The method comprises receiving, at a first device and from a vehicle, first information concerning driving properties of the vehicle. The method also comprises transmitting the first information to a second device such that a vehicle platoon is determined based on the first information. The method further comprises receiving, from the second device, the second information indicating the vehicle platoon to which the vehicle belongs. The method yet comprises generating third information for remotely controlling the vehicle based on the vehicle platoon. The method further comprises transmitting the third information to the vehicle.

In a second aspect, there is provided a method. The method comprises receiving, at a second device and from a first device, first information concerning driving properties of a vehicle. The method also comprises determining a vehicle platoon to which the vehicle belongs based on the first information. The method further comprises generating second information for controlling the vehicle platoon. The method yet comprises transmitting the second information to the first device.

In a third aspect, there is provided a method. The method comprises collecting, at a vehicle, first information concerning driving properties of the vehicle. The method also comprises transmitting the first information to a first device such that a vehicle platoon is determined based on the first information. The method further comprises receiving, from the first device, third information to be remotely controlled by first device based on the vehicle platoon.

In a fourth aspect, there is provided a first device. The first device comprises at least one processor; and at least one memory including computer program codes; the at least one memory and the computer program codes are configured to, with the at least one processor, cause the first device to receive, from a vehicle, first information concerning driving properties of the vehicle. The first device is also caused to transmit the first information to a second device such that a vehicle platoon is determined based on the first information. The first device is further caused to receive second information from the second device, the second information indicating the vehicle platoon to which the vehicle belongs. The first device is yet caused to generate third information to remotely control the vehicle based on the vehicle platoon. The first device is further caused to transmit the third information to the vehicle.

In a fifth aspect, there is provided a second device. The second device comprises at least one processor; and at least one memory including computer program codes; the at least one memory and the computer program codes are configured to, with the at least one processor, cause the second device to receive, from a first device, first information concerning driving properties of a vehicle. The second device is also caused to determine a vehicle platoon to which the vehicle belongs based on the first information. The second device is further caused to generate second information for controlling the vehicle platoon. The second device is yet caused to transmit the second information to the first device.

In a sixth aspect, there is provided a third device. The third device comprises at least one processor; and at least one memory including computer program codes; the at least one memory and the computer program codes are configured to, with the at least one processor, cause the third device to collect first information concerning driving properties of the vehicle. The third device is also caused to transmit the first information to a first device such that a vehicle platoon is determined based on the first information. The third device is further caused to receive, from the first device, third information to be remotely controlled by first device based on the vehicle platoon.

In a seventh aspect, there is provided an apparatus. The apparatus comprises means for receiving, from a vehicle, first information concerning driving properties of the vehicle; means for transmitting the first information to a second device such that a vehicle platoon is determined based on the first information; means for receiving second information from the second device, the second information indicating the vehicle platoon to which the vehicle belongs; means for generating third information to remotely control the vehicle based on the vehicle platoon; and means for transmitting the third information to the vehicle.

In an eighth aspect, there is provided an apparatus. The apparatus comprises means for receiving, from a first device, first information concerning driving properties of a vehicle; means for determining a vehicle platoon to which the vehicle belongs based on the first information; means for generating second information for controlling the vehicle platoon; and means for transmitting the second information to the first device.

In a ninth aspect, there is provided an apparatus. The apparatus comprises means for collecting first information concerning driving properties of the vehicle; means for transmitting the first information to a first device such that a vehicle platoon is determined based on the first information; and means for receiving, from the first device, third information to be remotely controlled by first device based on the vehicle platoon.

In a tenth aspect, there is provided a computer readable medium comprising program instructions for causing an apparatus to perform at least the method according to the above fourth, fifth, or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a schematic diagram of a communication system according to conventional technologies;

FIG. 2 illustrates a schematic diagram of a communication system according to embodiments of the present disclosure;

FIG. 3 illustrates a signaling chart of interactions between devices according to embodiments of the present disclosure;

FIG. 4 illustrates a schematic diagram of data structures according to embodiments of the present disclosure;

FIG. 5 illustrates a schematic diagram of data structures according to embodiments of the present disclosure;

FIG. 6 illustrates a schematic diagram of a system structure according to embodiments of the present disclosure;

FIG. 7 illustrates a flow chart of a method according to embodiments of the present disclosure;

FIG. 8 illustrates a flow chart of a method according to embodiments of the present disclosure;

FIG. 9 illustrates a flow chart of a method according to embodiments of the present disclosure;

FIG. 10 illustrates a simplified block diagram of an apparatus that is suitable for implementing embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:

(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a terminal device and a network device in the communication network may be performed according to any suitable generation communication protocols, including, but not limited to, the first generation (1G), the second generation (2G), 2.5G, 2.65G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In long term evolution (LTE) vehicle to everything (V2X), only broadcast mode has been specified at physical layer for sidelink communications. The realization of unicast/groupcast modes needs to be carried out at higher layers. On the contrary, new radio (NR) V2X sidelink communication considers the support of unicast/groupcast directly at physical layer.

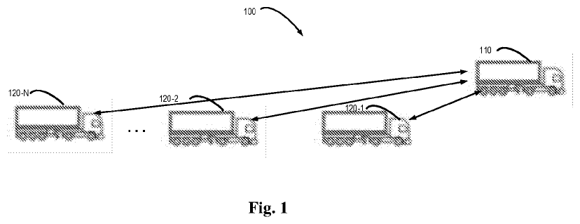

FIG. 1 illustrates a schematic diagram of a communication system according to conventional technologies. As shown in FIG. 1, there is a vehicle platoon 100. The vehicle platoon 100 comprises the vehicle 110, the vehicles 120-1. 120-2, . . . , 120-N, where N is any suitable integer number. The vehicle 110 may act as the head vehicle which is the platoon controller. The vehicles 120 may act as the follower vehicle. All vehicles 120 should be directly adjacent already before platoon initialization creation. The vehicles 120 are ready for full or partial autonomous driving, especially, Adaptive Cruise Control (ACC) being ready for platoon application which provides vehicle keep pre-set headway with front vehicle based on sensor.

The vehicles 120 may collect driving information and transmit the driving information to the vehicle 110. The vehicle 110 may determine the driving command based on the received driving information and transmit the driving command to the vehicles 120. The vehicle to vehicle (V2V) communication provides support the vehicle 110 to inform all platoon following vehicles 120 about its current trajectory and future maneuver (speed, acceleration, braking, steering, headway). So the V2V is a booster based on vehicle automation technology, specifically the vehicle 110 informs future maneuver and next following headway to all following vehicles. The main characteristic of conventional platoon achievement is to keep V2V based and head vehicle as platoon controller, to exchange platoon messages with autonomous driving following vehicles to operate a group of vehicles in a closely linked manner.

According to conventional technologies, there may be three generations of vehicle platoon, the first generation platoon, the second generation platoon and the third generation platoon.

First Generation platoon: business or called public fix or called static platoon at highway scenario, which is based on 802.11p DSRC V2V and followed head vehicle as platoon controller. Various business vehicles can form this kind of platoon, including truck, bus, logistics or emergency. Truck platoon has passed several road tests and SARTRE project is famous reference for this generation. In the first generation platoon, 802.11P Ad hoc VANET (w/o infrastructure) may show obvious performance degradation under vehicles dense environment, consequently SARTRE select highway relative sparse vehicle environment. This shows that 802.11P DSRC is not suitable when design new urban platoon application under dense vehicle environment;

Later on, SARTRE like platoon projects, begins to rely on LTE-V2V mode 3 (base station assisted) and mode 4 (base station unassisted), to test platoon minimum headway. When platoon headway based on LTE-V2V mode 3 is “D”, platoon headway based on LTE-V2V mode 4 is “3*D”, platoon headway based on 802.11P is “13*D” (service-level performance with different radio technologies. Platoon configuration and surroundings is 10-truck platoon, truck use C-ACC, 4-lane highway, 20 cars/lane generating interfering traffic around the platoon). SARTRE project has been finalized by 2012, already passed road test, achieved 6 meters headway and 6% fuel saving for following vehicles.

Second Generation platoon: try to find a platoon solution for dynamic private platoon at urban dense scenario. MAVEN type platoon application is compatible with all kinds of V2V evolved solutions such as cellular-base-station-assisted mode 3 V2V, cellular-base-station-unassisted mode 4 V2V, it's still obvious communication limitation impact its application architecture, causing still limited wireless coverage of hundreds of meters. The second generation platoon may design a new state machine to manage platoon dynamic statue migration. The main problem is very difficult to identify high value platoon candidates by head vehicles in so limited V2V coverage, thus requires candidates should be directly adjacent. But the second generation solution still follows V2V and Head vehicle as platoon controller. The key achievement is to improve V2V solution, from 802.11p DSRC Ethernet based v2v improved to V2V evolved solutions such as cellular-base-station-assisted mode 3 V2V, or cellular-base-station-unassisted mode 4 V2V.

Third Generation platoon: mostly keep second generation platoon solution, but a new V2N communication link is added, from head vehicle to Telco operator central cloud. The third generation platoon is very similar to the second generation platoon solution since it only adds one Telco operator central cloud which through V2N link connected to head vehicle. But as this generation platoon basically refer to second generation platoon, so it will keep low stable, difficult to use, and low platoon performance. The third generation platoon adds a new segment latency between central cloud to head vehicle, plus already existed ad hoc V2V wireless latency.

The common disadvantage of conventional platoon application is that head vehicle (for example, the vehicle 110) can only select potential platoon candidates in very limited geographical range based on V2V coverage and all candidates should be directly adjacent. As per urban dynamic private vehicles environment, it's very difficult to select high stable platoon candidates, therefore the platoon can only share very short common driving route with several intersections and lanes, then platoon has to dismiss. The high frequency oscillation appearance cannot really benefit urban traffic efficiency improvement and fuel saving.

Second main problems of this conventional platoon solution is that the current platoon solution head vehicle is lack of ability to remote drive control (directly hand over low level autonomous drive control from autonomous vehicle to platoon head vehicle) non-adjacent candidate to becomes adjacent. This weakness may restrict the possibility to form high stable platoon, no matter platoon creation phase or platoon is driving in the progress.

Third main problems of this conventional platoon solution is related with business mode, normally innovative application hope to be popularized, but former existing platoon solution will require existing autonomous driving no matter head vehicle or other platoon follower vehicles should pay to install extra resource for this platoon, also required to be installed new platoon software.

According to embodiments of the present disclosure, a first device receives driving information from vehicles and forwards the driving information to a network device. The second device determines the vehicle platoon based on the driving information and transmits the information related to the vehicle platoon to the first device. The first device determines control information to remotely drive the vehicles. In this way, the coverage of the vehicle platoon is increased and a dynamic platoon is formed. The first device controls the driving of the vehicles instead of the head vehicle, which reduces burden on the head vehicle.

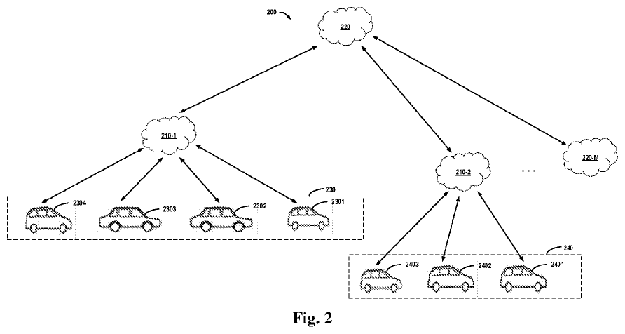

FIG. 2 illustrates a schematic diagram of a communication system 200 in which embodiments of the present disclosure can be implemented. The communication system 200, which is a part of a communication network, comprises a device 210-1, a device 210-2, . . . , a device 210-M, which can be collectively referred to as “first device(s) 210.” The M can be any suitable integer number. The communication system 200 further comprises a device 220 which is referred to as “second device 220”. It is to be understood that the number of devices shown in FIG. 2 is given for the purpose of illustration without suggesting any limitations. It also should be noted that the first device 210 and the second device 220 can be interchangeable.

In the communication system 200, the first device 210 and the second device 220 can communicate data and control information to each other. As shown in FIG. 2, the vehicle platoon 230 is controlled by the first device 210-1 and comprises the vehicles 2301, 2302, 2303 and 2304. The vehicle platoon is controlled by the first device 210-2 and comprises the vehicles 2401, 2402 and 2403. It should be noted that the vehicle platoon can comprise any suitable number of vehicles. The first device 210 may also control more than one vehicle platoon. The number of vehicles in one platoon vehicle shown in FIG. 2 is only an example not limitation.

Communications in the communication system 200 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

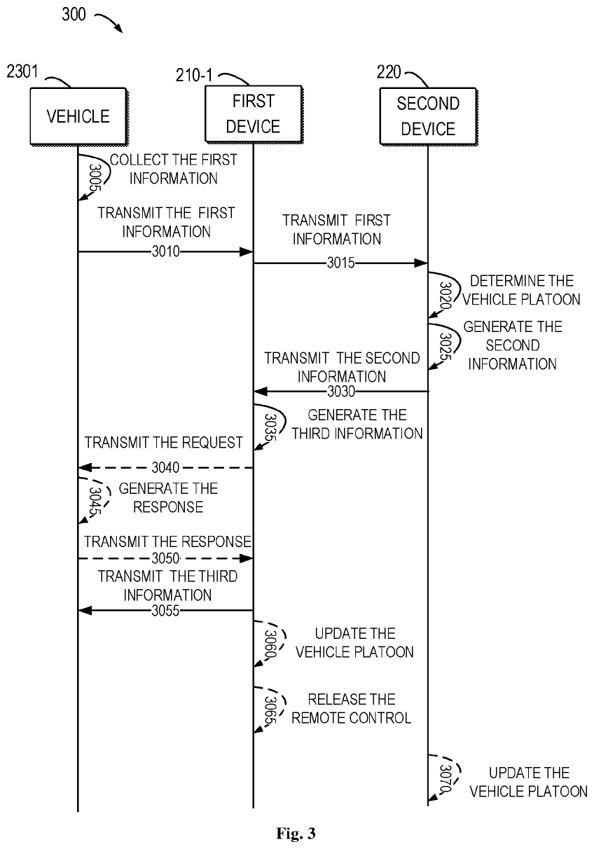

FIG. 3 illustrates a signaling chart of interactions 300 between devices according to embodiments of the present disclosure. The interactions 300 can be implemented among any suitable devices. For the purpose of illustrations, the interactions 300 are described with the reference to the first device 210-1, the second device 220 and the vehicle 2301.

The vehicle 2301 collects 3005 the first information about its driving properties. For example, the vehicle 2301 may collect the information using sensors. The driving properties may comprise one or more of velocity, travel direction, destination, current location, and expect arrival time. The driving properties may also comprise the location of the vehicle 2301 and/or its driving parameters. For example, the driving parameters may comprise one or more of throttle parameter, brake parameter or steering wheel parameter.

In some embodiments, the vehicle 2301 may register with first device 210. For example, the vehicle 2301 may inform the first device 210 its willingness to use vehicle platoon, its destination for this time driving plan, wishing arrival time. The first device 210-1 may respond the registration to the vehicle 2301.

The vehicle 2301 transmits 3010 the first information to the first device 210-1. In some embodiments, the vehicle 2301 may transmit the first information periodically. In other embodiments, the vehicle 2301 may transmit the first information if the driving properties are changed. The first information may also indicate the willingness to use remote control.

The first device 210-1 transmits 3015 the first information to the second device 220. The second device 220 determines 3020 the vehicle platoon to which the vehicle 2301 belongs based on the first information. In some embodiments, the second device 220 may analyze the first information and identity if the vehicle 2301 can join an existing vehicle platoon. For example, the second device 220 may determine the vehicle platoon based on the destination of the vehicle 2301. More specifically, if the destination of the vehicle 2301 is the same as the vehicle platoon 230, the second device 220 may determine that the vehicle 2301 belongs to the vehicle platoon 230. In other embodiments, the second device 220 may create a new vehicle platoon comprising the vehicle 2301. The vehicles in one vehicle platoon may not be adjacent to each other. If the vehicles are not adjacent, the vehicles will be remotely controlled to be adjacent. In this way, the geographical range of the vehicle platoon can be extended and a high stable platoon can be formed.

The second device 220 generates 3025 the second information based on the vehicle platoon (for example, the vehicle platoon 230). The second information may comprise at least one of: an identity of the vehicle platoon 230, a list of first devices, an identity of the first device 210-1, time of creation of the vehicle platoon 230, location of creation of the vehicle platoon 230, expected time of dismissing the vehicle platoon 230, an expected location of dismissing the vehicle platoon 230, a driving speed of the vehicle platoon 230, a driving route of the vehicle platoon 230, or a driving headway of the vehicle platoon 230, a list of vehicles in the vehicle platoon 230. The second information may comprise more than one vehicle platoon.

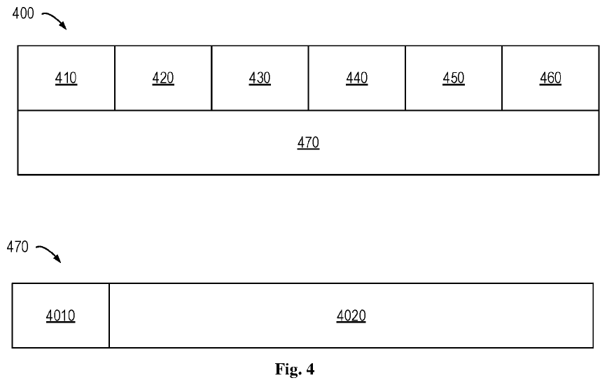

Referring to FIG. 4, FIG. 4 illustrates a schematic diagram of data structures according to embodiments of the present disclosure. The data structure 400 is an example data structure of the second information. As shown in FIG. 4, the data structure 400 may comprise a section 410 for the identity of vehicle platoon, a section 420 for the identity of the second device 220, a section 430 for a list of first devices, a section 440 for the first device 210-1, a section 450 for created time and location, and a section 460 for expected time and location of dismissing the vehicle platoon 230. The data structure 4110 may also comprise a section 470 for platoon driving plan in the first device 210-1. The second information may comprise a plurality of data structures 400.

The section 470 may comprise the subsection 4010 indicating the identity of the vehicle 2301. The section 470 may also comprise the subsection 4020 indicating the driving parameters. For example, the driving parameters may comprise one or more of: a time parameter, a location parameter, a speed parameter, a headway parameter.

Referring back to FIG. 3, the second device 220 transmits 3030 the second information to the first device 210-1. The second information indicates that the vehicle 2301 belongs to the vehicle platoon 230. The second information may comprise controlling information for a plurality of vehicle platoons.

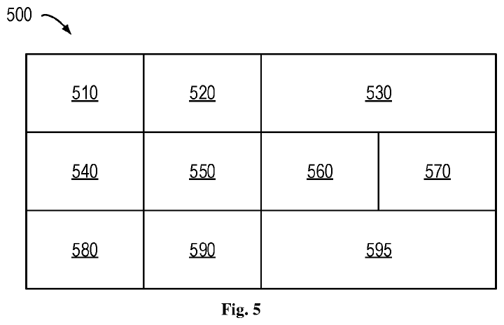

The first device 210-1 generates 3035 the third information based on the second information. The first device 210-1 may generate different third information specific to different vehicles, for example, 2301, 2302 and the like. With reference to FIG. 5, FIG. 5 illustrates an example data structure 500 of the third information. As shown in FIG. 5, the data structure 500 may comprise a section 510 for the identity of the vehicle 2301, the section 520 for the second device 220, the section 530 for the first device 210-1, the section 540 indicating the time parameter, the section 550 indicating the location parameter, the section 560 indicating the speed parameter, the section 570 indicating the headway parameter, the section 580 indicating the throttle parameter, the section 590 indicating the brake parameter and the section 595 indicating the steering wheel parameter.

For example, if the third information is specific to the vehicle 2301 which is the head vehicle, the third information may indicate the vehicle 2301 to change the speed to 120 km/h. The third information specific to the vehicle 2302 which is the follower, the third information may indicate the vehicle 2302 to change the speed to 120 km/h and keep the headway to be 1 m.

The first device 210-1 transmits 3055 the third information to the vehicle 2301. In some embodiments, the first device 210-1 may transmit 3040 the request to the vehicle 2301 to join the vehicle platoon 230. The vehicle 2301 may generate 3045 the response to the request. If the vehicle 2301 agrees to join the vehicle platoon 230, the vehicle 2301 may generate an acknowledgment. If the vehicle 2301 does not agree to join the vehicle platoon 230, the vehicle 2301 may generate a non-acknowledgment. The vehicle 2301 may transmit 3050 the response to the first device 210-1. If the response indicates the acknowledgment, the first device 210-1 may transmit the third information. In some embodiments, the vehicle 2301 may get information of the vehicles in the vehicle platoon.

In some embodiments, the first device 210-1 may update 3060 the vehicle platoon 230. If the vehicle 2301 is to leave the vehicle platoon 2301, the first device 210-1 may update the vehicle platoon. As an example, if the vehicle 2301 is driving closer to its destination, the first device 210-1 may transmit the third information to guide the vehicle 2301 to change its position in the vehicle platoon 230. The first device 210-1 may remotely drive the vehicle 2301 to a former planned specific location. For example, the vehicle 2301 may be guided to move to the end of the vehicle platoon 230 or move to another lane different from the lane in which the vehicle platoon 230 is located.

In some embodiments, if the vehicle 2301 does not follow the command for remotely controlling for several times, the second device 220 may determine to remove the vehicle 2301 from the vehicle platoon 230. For example, if the third information indicates that the speed is changed to 120 km/h, the vehicle 2301 may only change the speed to 125 km/h, the second device 220 may determine to remove the vehicle 2301 from the vehicle platoon 230.

The first device 210-1 may release 3065 the remote control. The vehicle 2301 may take its driving right back. The second device 220 may also update 3070 the vehicle platoon 230.

In other embodiments, if the vehicle platoon 230 is to break into two vehicle platoons, the first device 210-1 may also update 3060 the vehicle platoon 230. For example, if an external intruder suddenly breaks the vehicle platoon 230 or the time window of traffic light it too small to pass the whole vehicle platoon, the vehicle platoon 230 needs to break into two vehicles platoons. The second device 220 may generate a further vehicle platoon and update 3070 the vehicle platoon 230.

In a further embodiment, if several vehicle platoons are merged into one vehicle platoon, the first device 210-1 may also update 3060 the vehicle platoon 230. For example, if more than one non-adjacent vehicle platoons (for example, the vehicle platoons 230 and 240) are met or can be guide to become adjacent, the more than one non-adjacent vehicle platoons can be merged into one vehicle platoon. The first device 210-1 may update the vehicle platoon 230 to include the vehicles 2401, 2402 and 2403 from the vehicle 240 and delete the vehicle platoon 240. The second device 220 may also update the vehicle platoon 230 to include the vehicles 2401, 2402 and 2403 from the vehicle 240 and delete the vehicle platoon 240. If the vehicles in the vehicle platoon 230 and the vehicles in the vehicle platoon 240 are not adjacent, the second device 220 may generate controlling information for the first device 210-1 to guide the vehicle platoon 230 and the vehicles in the vehicle platoon 240 to be adjacent.

In another embodiment, if the vehicle platoon 230 reaches its destination, the first device 210-1 may update the vehicle platoon 230 by dismissing the vehicle platoon 230. The first device 210-1 may transmit “remote driving ending” to the vehicles in the vehicle platoon 230. The first device 210-1 may release 3065 the remote control and the second device 220 may also release the remote control.

In some embodiments, the vehicle 2301 may update the driving properties and generate the fourth information. The fourth information may comprise one or more of the update driving properties, information of inner sensors, information of outer sensors, information of vehicle networking, or digital map. The information of inner sensors may relate to the capability of the vehicle 2301. The information of outer sensors may comprise the driving information relate to other vehicles, for example, the headway. The information of vehicle networking may refer to vehicle networking messages. The digital map may be generated based on the information of inner sensors, information of outer sensors, or information of vehicle networking.

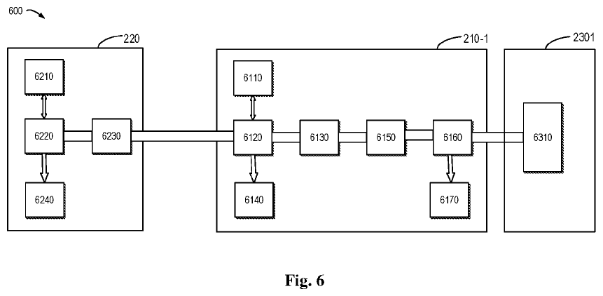

FIG. 6 illustrates a schematic diagram of a system structure according to embodiments of the present disclosure. It should be noted that the system structure shown in FIG. 6 is only an example not limitation.

There is a platoon concept area between the first device 210-1 and the second device 220. There is another remote driving area between the first device 210-1 and the vehicle 2301. The translator 6150 in the first device 210-1 may undertake two-direction translation and conversion between the “platoon concept area” and the “remote concept area.”

The second device 220 may manage several first devices 210, which, for example, may cover 10-20 km. One first device may cover 2-3 km and manage more than one vehicle platoons (for example, the vehicle platoons 230 and 240). The platoon master controller 6220 in the second device 220 may control the vehicle platoons. There are two modules of platoon digital twins, one platoon digital twin 6240 in the second device 220 and another platoon digital twin 6140 in the first device 210-1. The vehicle may periodically report to the first device 210-1 its location, driving speed, headway, adjacent front vehicle, current settings of low-level remote driving control parameters of accelerator, brake, and steering wheel. The platoon digital twins 6240 and 6140 may be created and updated based on the report from the vehicles.

The translator 6150 in the first device 210-1 which knows every vehicle in the vehicle platoon may update latest state of information of vehicle digital twin 6170 to the platoon digital twin 6140 inside the first device 210-1. The platoon digital twin 6140 in the first device 210-1 may create and update continuously each platoon digital twin including platoon current driving speed, platoon current driving route, platoon headway and the like. The convertor 6120 in the first device 210-1 may merge multi platoons digital twins into one package and update with the convertor 6230 inside the second device 220.

The convertor 6230 inside the second device 220 may merge multi platoons' next future platoon driving updating message into one package, then send to the first device 210-1 which will decompose into multi each platoon messages and send to the platoon slave controller 6130.

The first device 210-1 may manage multi vehicle platoons. Each vehicle platoon has itself platoon slave controller 6130 inside the first device 210-1 and map to one unique vehicle platoon to the translator 6150. The translator 6150 may decompose each platoon control command messages into multi vehicles remote driving command messages. Each vehicle has one unique vehicle remote driving controller 6160 in the first device, and one unique remote drive vehicle 6310 inside each vehicle. There is no any extra resource configuration requirement for vehicles which will to join this virtual platoon. There is also no need to install any complex platoon software for these vehicles. Vehicles are only aware that they are under remote driving controlled by first device.

There are existing data bases (DBs) in both first and second devices. 5G network performance log table also belong to this DB file. In the future, if there is a traffic accident in this kind of platoon application, this 5G network performance log table is the facility to check whether traffic accident is relative with 5G network performance unexpected degrading or some network malfunction. Both first and second devices 210-1 and 220 have a read time network performance degrading monitor, which will cause the first device 210-1 to inform all involving vehicles their platoon will be dismissed if serious network problems are found. The DB may also comprise recorded parameters including e2e round-trip network latency for the first and second devices 210-1 and 220, recorded parameters including V2N bandwidth between vehicle with radio (base station), bandwidth to the first and second devices 210-1 and 220, recorded parameters also including network incidents at any time from all related segments. Details of embodiments will be described with the reference to FIG. 6 as follows.

If the second information is received, the translator 6150 may translate and generate the third information. The translator 6150 may send the third information to the vehicle remote driving controller 6160 for remotely controlling the vehicle 2301.

Another function assigned to the translator 6150 may converge the vehicle digital twin 6170 of vehicles in one vehicle platoon into the platoon digital twin 6140. The converter 6120 may transmit the information of the platoon digital twin 6140 to the second device 220.

The second information received by the translator 6150 may normally comprise platoon speed, platoon headway, platoon driving route. The second information may be translated and decomposed into multi vehicle remote driving control command including vehicle's parameter list.

The vehicle 2301 may report its speed, headway together with all key sensors data (HD-Map) to the vehicle remote driving controller 6160 and the vehicle digital twin 6170. The vehicle remote driving controller 6160 may be one to one mapping to the vehicle such that the third information may only contain remote driving control command to one vehicle. The vehicle remote driving controller 6160 may transmit the third information to the vehicle 2301 including ask this vehicle 2301 at when (Time-X) to reach where (Location-Y) at speed-M and keep headway-N. The third information may also include parameters as throttle-O, brake-P, and Steering wheel-Q.

The master root process 6210 in the second device 220 may continuously analyze the first information to identity if the vehicle 2301 is feasible to join some existing vehicle platoons. The master root process 6210 in the second device 220 may inform the platoon master controller 6220 the determined vehicle platoon. The platoon master controller 6220 may also inform the platoon slave controller 6130 the determined vehicle platoon to remote drive non-adjacent vehicles. The platoon slave controller 6130 may inform the translator 6150 which will create the remote driving controller 6150. The platoon slave controller 6130 may keep link with the translator 6150. The translator 6150 may also keep link with the created remote driving controller 6160 for this vehicle 2301.

If this vehicle 2301 is already successfully be adjacent with existing platoon, the platoon master platoon in the second device 220 and the platoon slave platoon in the first device 210-1 may update the data base as a new vehicle has already joined. The first device 210-1 may continue executing the remote driving target for this vehicle 2301. This vehicle 2301 may continue reporting its driving state.

In some embodiments, the vehicle platoons (for example, the vehicle platoons 230 and 240) need to be updated continuously. The platoon master controller 6220 in the second device 220 may undertake platoon control, which leverages computing resources (including AI chipset and specific AI algorithm) and data resources including platoon digital twin 6240. The platoon master controller 6220 may form its predictive ability for platoon driving continuous real time optimization. The platoon master controller 6220 may periodically update itself existing platoon's driving route, driving speed, platoon headway. The platoon master controller 6220 may send “platoons control messages” to the converter 6230. The converter 6230 may merge all platoons control messages into platoon batch control messages (i.e., the second information) and send it to the first device 210-1.

The convertor 6120 in the first device 210-1 may split the platoon batch control messages into multi platoons control messages to the platoon slave controller 6130. The platoon slave controller 6130 may request its mapping translator 6150 to translate high level platoon driving command into low level remote driving parameter for each vehicle. The remote driving controller 6160 may control one vehicle' remote driving. The remote driving controller 6160 may send low level remote driving control commands to this vehicle 2301 through 5G V2N. The vehicle 2301 may feedback its latest driving state including driving speed, headway, together with all variant's sensors value, its HD-Map to the first device 210-1. The first device 210-1 may update relative vehicle digital twin 6170 accordingly. Subsequently, the first device 210-1 may update relative platoon digital twin 6140. The first device 210-1 may update the platoon digital twin 6140 to the second device 220. The platoon digital twin 6240 in the second device 220 may periodically be updated to latest state.

In some embodiments, the vehicle 2301 may leave the vehicle platoon 230. The first device 210-1 may guide this vehicle 2301 to change its position in this vehicle platoon. The first device 210-1 may release its control right for remote driving the vehicle 2301. The platoon slave controller 6130 may release the remote drive controller 6160. The first device 210-1 and the second device 220 may update the list of vehicles in the vehicle platoon 230 in the DB and update the platoon twins 6240 and 6140, respectively.

In some embodiments, the vehicle platoon 230 may be split into more than one vehicle platoon. The second device 220 may keep the current platoon master controller 6220 and update the platoon digital twin 6240 and relative DB for only half of this vehicle platoon 230. The first device 210-1 may also keep the current platoon slave controller 6130, the translator 6150 and the remote drive controller 6160. The first device 210-1 may also update the platoon digital twin 6140 and the relative DB for half of the vehicle platoon 230. For another half of this vehicle platoon, the first device 210-1 may request to create a new vehicle platoon. In the second device 220, a new platoon mater controller and a new platoon digital twin may be created. The former items for the half vehicle platoon 230 may be updated to latest state. In the first device 210-1, a new platoon slave controller with its digital twin, translator and a new remote drive controller may be created. The relative DB may also be updated to latest state.

In some embodiments, the vehicle platoons 230 and 240 may be merged into one vehicle platoon. The second device 220 may merge two platoon digital twins into one platoon digital twin and update relative DB. The second device 220 may keep one platoon master controller and delete the other platoon master controller. The first device 210-1 may also merge two platoon digital twins into one platoon digital twin and update relative “DB”. The first device 210-1 may keep one platoon slave controller, platoon digital twin and translator for one vehicle platoon (for example, the vehicle platoon 230) and delete the other platoon slave controller, platoon digital twin and translator for the other vehicle platoon (for example, the vehicle platoon 240). The second device 220 may relink the remote drive controller with the vehicle digital twin to the translator then to link to the platoon slave controller.

In some embodiments, the vehicle platoon 230 may reach destination. The first device 210-1 may first multi messages for remote driving ending to all vehicles belong to this vehicle platoon 230. The first device 210-1 may release all emote drive controllers related to this vehicle platoon 230. The first device 210-1 may release the translator, platoon slave controller, and platoon digital twin and relative DB which are related to this vehicle platoon 230. The second device 220 may also release the platoon master controller with the platoon digital twin and the relative DB which are related to this vehicle platoon 230.

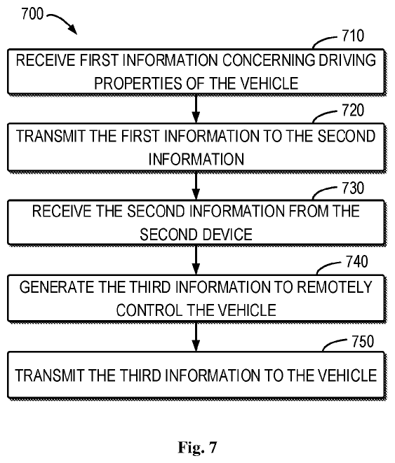

FIG. 7 illustrates a flow chart of method 700 according to embodiments of the present disclosure. The method 700 can be implemented at any suitable devices. For example, the method may be implemented at the first device 210-1.

At block 710, the first device 210-1 receives the first information concerning the driving properties of the vehicle 2301. The driving properties may comprise one or more of velocity, travel direction, destination, current location, and expect arrival time. The driving properties may also comprise the location of the vehicle 2301 and/or its driving parameters. For example, the driving parameters may comprise one or more of throttle parameter, brake parameter or steering wheel parameter.

At block 720, the first device 210-1 transmits the first information to the second device 220. The first information may be used for determining the vehicle platoon.

At block 730, the first device 210-1 receives the second information. The second information may comprise at least one of: an identity of the vehicle platoon 230, a list of first devices, an identity of the first device 210-1, time of creation of the vehicle platoon 230, location of creation of the vehicle platoon 230, expected time of dismissing the vehicle platoon 230, an expected location of dismissing the vehicle platoon 230, a driving speed of the vehicle platoon 230, a driving route of the vehicle platoon 230, or a driving headway of the vehicle platoon 230, a list of vehicles in the vehicle platoon 230. The second information may comprise more than one vehicle platoon.

At block 740, the first device 210-1 generates the third information for remotely controlling the vehicle 2301 based on the second information. The third information may comprise the identity of the vehicle 2301, the second device 220, the first device 210-1, the time parameter, the location parameter, the speed parameter, the headway parameter, the throttle parameter, the brake parameter and the steering wheel parameter.

At block 750, the first device 210-1 transmits the third information to the vehicle. In some embodiments, the first device 210-1 may transmit the request to the vehicle 2301 to join the vehicle platoon 230. The first device 210-1 may receive the response from the vehicle 2301. If the response indicates the acknowledgment, the first device 210-1 may transmit the third information

In some embodiments, the first device 210-1 may update the vehicle platoon 230. If the vehicle 2301 is to leave the vehicle platoon 2301, the first device 210-1 may update the vehicle platoon. As an example, if the vehicle 2301 is driving closer to its destination, the first device 210-1 may transmit the third information to guide the vehicle 2301 to change its position in the vehicle platoon 230. The first device 210-1 may remotely drive the vehicle 2301 to a former planned specific location. For example, the vehicle 2301 may be guided to move to the end of the vehicle platoon 230 or move to another lane different from the lane in which the vehicle platoon 230 is located. The first device 210-1 may release the remote control. The vehicle 2301 may take its driving right back.

In other embodiments, if the vehicle platoon 230 is to break into two vehicle platoons, the first device 210-1 may also update the vehicle platoon 230. For example, if an external intruder suddenly breaks the vehicle platoon 230 or the time window of traffic light it too small to pass the whole vehicle platoon, the vehicle platoon 230 needs to break into two vehicles platoons. In some embodiments, the first device 210-1 may receive an indication to split the vehicle platoon 230.

In a further embodiment, if several vehicle platoons are merged into one vehicle platoon, the first device 210-1 may also update 3060 the vehicle platoon 230. For example, if more than one non-adjacent vehicle platoons (for example, the vehicle platoons 230 and 240) are met or can be guide to become adjacent, the more than one non-adjacent vehicle platoons can be merged into one vehicle platoon. The first device 210-1 may update the vehicle platoon 230 to include the vehicles 2401, 2402 and 2403 from the vehicle 240 and delete the vehicle platoon 240. In some embodiments, the first device 210-1 may receive a further indication to merge the vehicle platoon 230 and the further vehicle platoon 240. If the vehicles in the vehicle platoon 230 and the vehicles in the vehicle platoon 240 are not adjacent, the first device 220-1 may transmit controlling information for the first device 210-1 to guide the vehicle platoon 230 and the vehicles in the vehicle platoon 240 to be adjacent.

In another embodiment, if the vehicle platoon 230 reaches its destination, the first device 210-1 may update the vehicle platoon 230 by dismissing the vehicle platoon 230. The first device 210-1 may transmit “remote driving ending” to the vehicles in the vehicle platoon 230. The first device 210-1 may release the remote control and the second device 220 may also release the remote control. In other embodiments, the first device 210-1 may receive from the second device 220 another indication to dismiss the vehicle platoon 230.

In some embodiments, the first device 210-1 may receive fourth information from the vehicle 2301. The fourth information may comprise one or more of updated driving properties of the vehicle, information of internal information collecting sensors, external information collecting sensors, information of received vehicle-to-vehicle messages, or digital map. The first device 210-1 may transmit the fourth information to the second device 220.

In some embodiments, the first device 210-1 may receive first guide information to guide non-adjacent candidate vehicles to be adjacent to form the vehicle platoon 230 and transmit the first guide information to the non-adjacent candidate vehicles.

In some embodiments, the first device 210-1 may receive the second guide information to guide the vehicle platoon and a further platoon to become adjacent and transmit the second guide information to the vehicles in the vehicle platoon 230 and the further vehicle platoon 240.

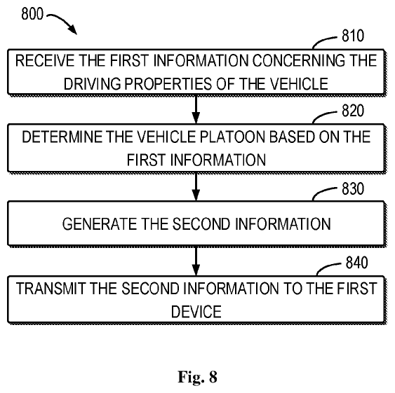

FIG. 8 illustrates a flow chart of method 800 according to embodiments of the present disclosure. The method 800 can be implemented at any suitable devices. For example, the method may be implemented at the second device 220.

At block 810, the second device 220 receives the first information concerning the driving properties of the vehicle 2301 from the first device 210-1. The driving properties may comprise one or more of velocity, travel direction, destination, current location, and expect arrival time. The driving properties may also comprise the location of the vehicle 2301 and/or its driving parameters. For example, the driving parameters may comprise one or more of throttle parameter, brake parameter or steering wheel parameter.

At block 820, the second device 220 determines the vehicle platoon to which the vehicle 2301 belongs based on the first information. In some embodiments, the second device 220 may analyze the first information and identity if the vehicle 2301 can join an existing vehicle platoon. For example, the second device 220 may determine the vehicle platoon based on the destination of the vehicle 2301. More specifically, if the destination of the vehicle 2301 is the same as the vehicle platoon 230, the second device 220 may determine that the vehicle 2301 belongs to the vehicle platoon 230. In other embodiments, the second device 220 may form a new vehicle platoon comprising the vehicle 2301. The vehicles in one vehicle platoon may not be adjacent to each other. In this way, the geographical range of the vehicle platoon can be extended and a high stable platoon can be formed.

At block 830, the second device 220 generates the second information based on the vehicle platoon (for example, the vehicle platoon 230). The second information may comprise at least one of: an identity of the vehicle platoon 230, a list of first devices, an identity of the first device 210-1, time of creation of the vehicle platoon 230, location of creation of the vehicle platoon 230, expected time of dismissing the vehicle platoon 230, an expected location of dismissing the vehicle platoon 230, a driving speed of the vehicle platoon 230, a driving route of the vehicle platoon 230, or a driving headway of the vehicle platoon 230, a list of vehicles in the vehicle platoon 230. The second information may comprise more than one vehicle platoon. For example, the second information may comprise the vehicle platoons 230 and 240.

At block 840, the second device 220 transmits the second information to the first device 210-1. The second information indicates that the vehicle 2301 belongs to the vehicle platoon 230.

In some embodiments, the second device 220 may determine to split the vehicle platoon 230 into more than one vehicle platoon based on further driving properties of a plurality of vehicles in the vehicle platoon. The second device 220 may update the vehicle platoon to generate more than one vehicle platoon. The second device 220 may generate an indication to split the vehicle platoon 230. The second device 220 may transmit the indication to the first device 210-1.

In some embodiments, the second device 220 may determine to merge the vehicle platoon 230 and a further vehicle platoon 240 based on further driving properties of a plurality of vehicles in the vehicle platoon 230 and the further vehicle platoon 240. The second device 220 may generate a further indication to merge the vehicle platoon 230 and the further vehicle platoon 240 and transmit he further indication to the first device 210-1. The second device 220 may generate the third guide information to guide the vehicle platoon 230 and the further vehicle platoon 240 to become adjacent and transmit the third information to the first device 210-1. The second device may update the vehicle platoon 230 and adjust information related to the updated vehicle platoon, for example, a new vehicle list, a new driving speed, a new driving rout, a new driving headway and the like.

In some embodiments, if the destination of the vehicle platoon 230 is reached or the second device 220 determines to dismiss the vehicle platoon, the second device 220 may generate another indication to dismiss the vehicle platoon 230 and transmit another indication to the first device 210-1.

In some embodiments, if the vehicle 2301 does not follow the command for remotely controlling for several times, the second device 220 may determine to remove the vehicle 2301 from the vehicle platoon 230. For example, if the third information indicates that the speed is changed to 120 km/h, the vehicle 2301 may only change the speed to 125 km/h; the second device 220 may determine to remove the vehicle 2301 from the vehicle platoon 230.

In some embodiments, the second device 220 may generate the first guide information to guide non-adjacent candidate vehicles to be adjacent to form the vehicle platoon 230 and transmit the first guide information to the first device 210-1.

In some embodiments, the second device 220 may generate the second guide information to guide the vehicle platoon 230 and the further vehicle platoon 240 to become adjacent and transmit the second guide information to the first device 210-1.

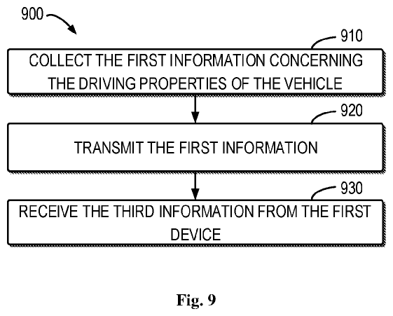

FIG. 9 illustrates a flow chart of method 900 according to embodiments of the present disclosure. The method 900 can be implemented at any suitable devices. For example, the method may be implemented at the vehicle 2301.

In some embodiments, the vehicle 2301 may register online. The vehicle 2301 may be ready for both levels 4 or 5 autonomous driving. The vehicle 2301 may be ready for remote driving under cloud autonomous controlled. The vehicle 2301 may be ready for V2X cooperative driving. The vehicle 2301 may be ready for 5G V2N

At block 910, the vehicle 2301 collects the first information concerning driving properties of the vehicle. For example, the vehicle 2301 may collect the information using sensors. The driving properties may comprise one or more of an indication indicating willingness to be remotely controlled, velocity, travel direction, destination, current location, and expect arrival time. The driving properties may also comprise the location of the vehicle 2301 and/or its driving parameters. For example, the driving parameters may comprise one or more of throttle parameter, brake parameter or steering wheel parameter. In some embodiments, the vehicle 2301 may get information of the vehicles in the vehicle platoon.

In some embodiments, the vehicle 2301 may register with first device 210. For example, the vehicle 2301 may inform the first device 210 its willingness to use vehicle platoon, its destination for this time driving plan, wishing arrival time.

At block 920, the vehicle 2301 transmits the first information to the first device 210-1. In some embodiments, the vehicle 2301 may transmit the first information periodically. In other embodiments, the vehicle 2301 may transmit the first information if the driving properties are changed.

At block 930, the vehicle 2301 receives the third information from the first device 210-1. The third information may comprise at least one of: an identity of the vehicle, speed, a parameter of throttle setting, a parameter of brake setting and a parameter of steering wheel setting.

In some embodiments, the vehicle 2301 may receive the request to join the vehicle platoon 230. The vehicle 2301 may generate the response to the request. If the vehicle 2301 agrees to join the vehicle platoon 230, the vehicle 2301 may generate an acknowledgment. If the vehicle 2301 does not agree to join the vehicle platoon 230, the vehicle 2301 may generate a non-acknowledgment.

In some embodiments, the vehicle 2301 may update the driving properties and generate the fourth information. The fourth information may comprise one or more of the update driving properties, information of inner sensors, information of outer sensors, information of vehicle networking, or digital map. The information of inner sensors may relate to the capability of the vehicle 2301. The information of outer sensors may comprise the driving information relate to other vehicles, for example, the headway. The information of vehicle networking may refer to vehicle networking messages. The digital map may be generated based on the information of inner sensors, information of outer sensors, or information of vehicle networking.

According to embodiments of the present disclosure, the coverage of the vehicle platoon has been extended and high stable platoon is formed. The role of platoon controller is assigned to network side so that the vehicle doesn't require to install any extra resources for this platoon application and to pay platoon application fee each time when vehicle join this platoon application. Furthermore, the vehicles in the vehicle platoon don't require installing any specific complex platoon software and will not receiving and transmitting any platoon messages. Embodiments of the present disclosure can provide very high network performance. Furthermore this vehicle platoon can drive at very high speed and a larger size of the vehicle platoon can be achieved.

In some embodiments, an apparatus for performing the method 700 (for example, the first device 210-1) may comprise respective means for performing the corresponding steps in the method 700. These means may be implemented in any suitable manners. For example, it can be implemented by circuitry or software modules.

In some embodiments, the apparatus comprises means for receiving, at a first device and from a vehicle, first information concerning driving properties of the vehicle; means for transmitting the first information to a second device such that a vehicle platoon is determined by the second device based on the first information; means for receiving, from the second device, the second information indicating the vehicle platoon to which the vehicle belongs; means for generating third information for remotely controlling the vehicle based on the vehicle platoon; and means for transmitting the third information to the vehicle.

In some embodiments, the driving properties of the vehicle comprise at least one of: velocity, travel direction, destination, current location, an expect arrival time or an indication indicating a wish to join a vehicle platoon.

In some embodiments, the means for generating the third information comprises: means for obtaining driving parameters of the vehicle platoon from the second device; and means for generating the third information based on the driving parameters.

In some embodiments, the means for transmitting the third information to the vehicle comprises: means for transmitting a request to the vehicle to join the vehicle platoon; and means for in accordance with a determination that an acknowledgment to the request is received, transmitting the third information to the vehicle.

In some embodiments, the third information comprises at least one of: an identity of the vehicle, an updated driving speed, an updated headway, a parameter of throttle setting, a parameter of brake setting, or a parameter of steering wheel setting.

In some embodiments, the apparatus comprises means for receiving first guide information from the second device; and means for transmitting, to non-adjacent candidate vehicles, the first guide information to guide the non-adjacent candidate vehicles to be adjacent to form the vehicle platoon.

In some embodiments, the second information comprises at least one of: an identity of the vehicle platoon, an identity of the first device, time of creation of the vehicle platoon, location of creation of the vehicle platoon, expected time of dismissing the vehicle platoon, an expected location of dismissing the vehicle platoon, a driving speed of the vehicle platoon, a driving route of the vehicle platoon, or a driving headway of the vehicle platoon, a list of vehicles in the vehicle platoon.

In some embodiments, the apparatus further comprises means for receiving second guide information from the second device; and means for transmitting the second guide information to guide the vehicle platoon and a further platoon to become adjacent.

In some embodiments, the apparatus further comprises means for in accordance with a determination that the vehicle is to leave the vehicle platoon, transmitting release information to the vehicle to release remote control of the vehicle; and means for updating the vehicle platoon to remove the vehicle from the vehicle platoon.

In some embodiments, the apparatus further comprises means for receiving an indication from the second device to split the vehicle platoon into more than one vehicle platoon; and means for updating the vehicle platoon to generate more than one vehicle platoon.

In some embodiments, the apparatus further comprises means for receiving a further indication from the second device to merge the vehicle platoon with a further vehicle platoon; means for transmitting third guide information to guide the vehicle platoon and the further vehicle platoon to become adjacent; and means for updating the vehicle platoon to merge the further vehicle platoon by causing the further vehicle platoon to be adjacent to the vehicle platoon.

In some embodiments, the apparatus further comprises means for in accordance with a determination that a destination of the vehicle platoon is reached, transmitting dismiss information to a plurality of vehicles in the vehicle platoon; and means for releasing remote control of the plurality of vehicles.

In some embodiments, the apparatus comprises means for receiving fourth information from the vehicle, the fourth information comprising one or more of updated driving properties of the vehicle, information of internal information collecting sensors, external information collecting sensors, information of received vehicle-to-vehicle messages, or digital map; and means for transmitting the fourth information to the second device.

In some embodiments, the first device comprises a network device and the second device comprises a further network device.

In some embodiments, an apparatus for performing the method 800 (for example, the second device 220) may comprise respective means for performing the corresponding steps in the method 800. These means may be implemented in any suitable manners. For example, it can be implemented by circuitry or software modules.

In some embodiments, the apparatus comprises means for receiving, at a second device and from a first device, first information concerning driving properties of a vehicle; means for determining a vehicle platoon to which the vehicle belongs based on the first information; means for generating second information for controlling the vehicle platoon; and means for transmitting the second information to the first device.

In some embodiments, the driving properties of the vehicle comprise at least one of: velocity, travel direction, destination, current location, and expect arrival time.

In some embodiments, the second information comprises at least one of: an identity of the vehicle platoon, an identity of the first device, time of creation of the vehicle platoon, location of creation of the vehicle platoon, expected time of dismissing the vehicle platoon, an expected location of dismissing the vehicle platoon, a driving speed of the vehicle platoon, a driving route of the vehicle platoon, or a driving headway of the vehicle platoon, a list of vehicles in the vehicle platoon.

In some embodiments, the apparatus further comprises means for generating first guide information to guide non-adjacent candidate vehicles to be adjacent to form the vehicle platoon; and means for transmitting the first guide information to the first device.

In some embodiments, the apparatus further comprises means for generating second guide information to guide the vehicle platoon and a further platoon to become adjacent; and means for transmitting the second guide information to the first device.

In some embodiments, the apparatus further comprises means for in accordance a determination that the vehicle is to leave the vehicle platoon, updating the second information to remove the vehicle.

In some embodiments, the apparatus further comprises means for determining to split the vehicle platoon into more than one vehicle platoon based on further driving properties of a plurality of vehicles in the vehicle platoon; means for updating the vehicle platoon to generate more than one vehicle platoon; means for generating an indication to split the vehicle platoon; and means for transmitting the indication to the first device.

In some embodiments, the apparatus further comprises means for determining to merge the vehicle platoon and a further vehicle platoon based on further driving properties of a plurality of vehicles in the vehicle platoon and the further vehicle platoon; means for generating a further indication to merge the vehicle platoon and the further vehicle platoon; means for transmitting the further indication; means for generating third guide information to guide the vehicle platoon and the further vehicle platoon to become adjacent; means for transmitting the third guide information to the first device; means for updating the vehicle platoon to merge the further vehicle; and means for adjusting information related to the merged vehicle platoon.

In some embodiments, the apparatus further comprises means for in accordance with a determination that a destination of the vehicle platoon is reached, releasing the vehicle platoon.

In some embodiments, the means for determining the vehicle platoon comprises: means for in accordance with a determination that a plurality of vehicles in the vehicle platoon are non-adjacent, generating controlling information to control the plurality of vehicles to be adjacent.

In some embodiments, the first device comprises a network device and the second device comprises a further network device.

In some embodiments, the apparatus further comprises means for receiving fourth information from the first device, the fourth information comprising one or more of updated driving properties of the vehicle, information of internal information collecting sensors, external information collecting sensors, information of received vehicle-to-vehicle messages, or digital map; and means for updating the second information based on the fourth information.

In some embodiments, an apparatus for performing the method 900 (for example, the vehicle 2301) may comprise respective means for performing the corresponding steps in the method 900. These means may be implemented in any suitable manners. For example, it can be implemented by circuitry or software modules. collecting, at a vehicle, first information concerning driving properties of the vehicle;

In some embodiments, the apparatus comprises means for transmitting the first information to a first device such that a vehicle platoon is determined based on the first information; and means for receiving, from the first device, third information to be remotely controlled by first device based on the vehicle platoon.

In some embodiments, the driving properties of the vehicle comprise at least one of: an indication indicating willingness to be remotely controlled, velocity, travel direction, destination, current location, an expect arrival time, or an indication indicating a wish to join a vehicle platoon.

In some embodiments, the third information comprises at least one of: an identity of the vehicle, an updated speed, an updated headway, a parameter of throttle setting, a parameter of brake setting and a parameter of steering wheel setting.

In some embodiments, the apparatus further comprises means for receiving a request from the first device to join the vehicle platoon; and means for in accordance with a determination to join the vehicle platoon, transmitting an acknowledgment to the first device.

In some embodiments, the means for transmitting the first information comprises: means for transmitting a request to register with the second device, the request comprising the first information.

In some embodiments, the apparatus further comprises means for updating the driving properties of the vehicle; means for generating fourth information comprising one or more of updated driving properties of the vehicle, information of internal information collecting sensors, external information collecting sensors, information of received vehicle-to-vehicle messages, or digital map; and means for transmitting the fourth information to the firs device.

In some embodiments, the apparatus further comprises means for receiving, from the first device, first guide information to guide non-adjacent candidate vehicles to be adjacent to form the vehicle platoon.

In some embodiments, the apparatus further comprises means for receiving, from the first device, second guide information to guide the vehicle platoon and a further platoon to become adjacent.

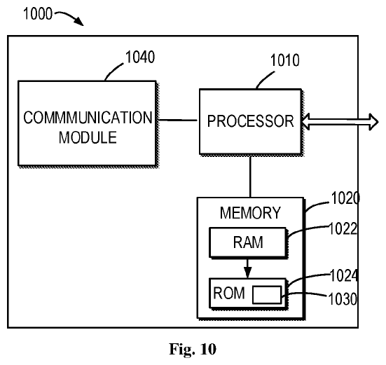

FIG. 10 is a simplified block diagram of a device 1000 that is suitable for implementing embodiments of the present disclosure. The device 1000 may be provided to implement the communication device, for example the first device 210-1, the second device 220, or the vehicle as shown in FIG. 2. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

Embodiments of the present disclosure may be implemented by means of the program 1020 so that the device 1000 may perform any process of the disclosure as discussed with reference to FIGS. 3 to 9. Embodiments of the present disclosure may also be implemented by hardware or by a combination of software and hardware.

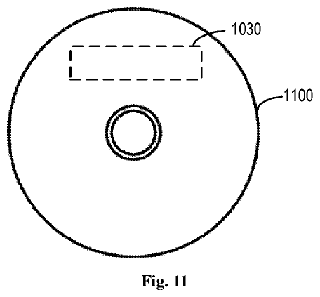

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

It should be appreciated that future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications, this may mean node operations to be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of labor between core network operations and base station operations may vary depending on implementation.

In an embodiment, the server may generate a virtual network through which the server communicates with the distributed unit. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Therefore, in an embodiment, a CU-DU architecture is implemented. In such case the device 1000 may be comprised in a central unit (e.g. a control unit, an edge cloud server, a server) operatively coupled (e.g. via a wireless or wired network) to a distributed unit (e.g. a remote radio head/node). That is, the central unit (e.g. an edge cloud server) and the distributed unit may be stand-alone apparatuses communicating with each other via a radio path or via a wired connection. Alternatively, they may be in a same entity communicating via a wired connection, etc. The edge cloud or edge cloud server may serve a plurality of distributed units or a radio access networks. In an embodiment, at least some of the described processes may be performed by the central unit. In another embodiment, the device 1000 may be instead comprised in the distributed unit, and at least some of the described processes may be performed by the distributed unit.

In an embodiment, the execution of at least some of the functionalities of the device 900 may be shared between two physically separate devices (DU and CU) forming one operational entity. Therefore, the apparatus may be seen to depict the operational entity comprising one or more physically separate devices for executing at least some of the described processes. In an embodiment, such CU-DU architecture may provide flexible distribution of operations between the CU and the DU. In practice, any digital signal processing task may be performed in either the CU or the DU and the boundary where the responsibility is shifted between the CU and the DU may be selected according to implementation. In an embodiment, the device 1000 controls the execution of the processes, regardless of the location of the apparatus and regardless of where the processes/functions are carried out.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 as described above with reference to FIG. 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-44. (canceled)

45. A method comprising:
receiving, at a first device and from a vehicle, first information concerning driving properties of the vehicle;
transmitting the first information to a second device such that a vehicle platoon is determined by the second device based on the first information;
receiving, from the second device, second information indicating the vehicle platoon to which the vehicle belongs;
generating third information for remotely controlling the vehicle based on the vehicle platoon; and
transmitting the third information to the vehicle.

46. The method of claim 45, wherein the driving properties of the vehicle comprise at least one of:
velocity, travel direction, destination, current location, an expect arrival time, or an indication indicating a wish to join a vehicle platoon.

47. The method of claim 45, wherein generating the third information comprises:
obtaining driving parameters of the vehicle platoon from the second device; and
generating the third information based on the driving parameters.

48. The method of claim 45, wherein transmitting the third information to the vehicle comprises:
transmitting a request to the vehicle to join the vehicle platoon; and
in accordance with a determination that an acknowledgment to the request is received, transmitting the third information to the vehicle.

49. The method of claim 45, wherein the third information comprises at least one of: an identity of the vehicle, an updated driving speed, an updated headway, a parameter of throttle setting, a parameter of brake setting, or a parameter of steering wheel setting.

50. The method of claim 45, further comprising:
receiving first guide information from the second device; and
transmitting, to non-adjacent candidate vehicles, the first guide information to guide the non-adjacent candidate vehicles to be adjacent to form the vehicle platoon.

51. The method of claim 45, wherein the second information comprises at least one of: an identity of the vehicle platoon, an identity of the first device, time of creation of the vehicle platoon, location of creation of the vehicle platoon, expected time of dismissing the vehicle platoon, an expected location of dismissing the vehicle platoon, a driving speed of the vehicle platoon, a driving route of the vehicle platoon, or a driving headway of the vehicle platoon, a list of vehicles in the vehicle platoon.

52. The method of claim 45, further comprising:
receiving second guide information from the second device; and
transmitting the second guide information to guide the vehicle platoon and a further platoon to become adjacent.

53. The method of claim 45, further comprising:
in accordance with a determination that the vehicle is to leave the vehicle platoon, transmitting release information to the vehicle to release remote control of the vehicle; and
updating the vehicle platoon to remove the vehicle from the vehicle platoon.

54. The method of claim 45, further comprising:
receiving an indication from the second device to split the vehicle platoon into more than one vehicle platoon; and
updating the vehicle platoon to generate more than one vehicle platoon.

55. The method of claim 45, further comprising:
receiving a further indication from the second device to merge the vehicle platoon with a further vehicle platoon;
transmitting third guide information to guide the vehicle platoon and the further vehicle platoon to become adjacent; and
updating the vehicle platoon to merge the further vehicle platoon.

56. The method of claim 45, further comprising:
in accordance with a determination that a destination of the vehicle platoon is reached, transmitting dismiss information to a plurality of vehicles in the vehicle platoon; and
releasing remote controlling of the plurality of vehicles.

57. The method of claim 45, further comprising:
receiving fourth information from the vehicle, the fourth information comprising one or more of updated driving properties of the vehicle, information of internal information collecting sensors, external information collecting sensors, information of received vehicle-to-vehicle messages, or digital map; and
transmitting the fourth information to the second device.

58. The method of claim 45, wherein the first device comprises a network device and the second device comprise a further network device.

59. An apparatus comprising means for performing a method according to claim 45.
